(19) United States
(12) Patent Application Publication
(10) Pub. No.: US 2026/0104161 A1
(43) Pub. Date: Apr. 16, 2026

(54) LIGHTING FIXTURE

(71) Applicant: ABL IP Holding, LLC, Atlanta, GA (US)

(72) Inventors: Chelsea TOWNES, Tampa, FL (US); Lucas VAN DYKE, Alpharetta, GA (US); Eyosias GEDION, Snellville, GA (US); Charlie VASQUEZ, Atlanta, GA (US); Mayur MENON, Cumming, GA (US); Ryan LOGGINS, Atlanta, GA (US)

(21) Appl. No.: 19/353,210

(22) Filed: Oct. 8, 2025

Related U.S. Application Data
(60) Provisional application No. 63/705,579, filed on Oct. 10, 2024.

(51) Int. Cl. F21V 29/83; F21V 29/74

(52) U.S. Cl. CPC F21V 29/83; F21V 29/74

(57) ABSTRACT

A lighting fixture may include a frame, a light source coupled to the frame, and a driver. The light source may include a first lighting segment and a second lighting segment spaced apart from the first lighting segment by a gap. The driver may be disposed between the first and second lighting segments such that air can flow into the gap and over at least a portion of the driver.

### CROSS-REFERENCE TO RELATED APPLICATIONS

The present application claims the benefit of U.S. Provisional Application Ser. No. 63/705,579, entitled Lighting Fixture, filed on Oct. 10, 2024, which is fully incorporated herein by reference.

### TECHNICAL FIELD

The present disclosure is generally directed to lighting fixtures and more specifically to lighting fixture thermal management.

### BACKGROUND INFORMATION

Building lighting systems may include a variety of lighting fixtures including ceiling fixtures, wall fixtures, free-standing fixtures, and/or any other type of lighting fixture. Ceiling fixtures may be suspended from a ceiling and include a frame, a driver, and a light source electrically coupled to the driver. The driver is configured to provide power to the light source such that the light source generates illumination. For example, depending on application, the light source may be configured between at least 8,000 lumens and at least 100,000 lumens. The driver and light source generate heat, which may increase with increasing illumination. For example, the driver and/or the light source may be exposed to temperatures of at least 55 degrees Celsius during operation. Insufficient heat dissipation may encourage premature failure of the driver and/or light source.

### BRIEF DESCRIPTION OF THE DRAWINGS

These and other features and advantages will be better understood by reading the following detailed description, taken together with the drawings, wherein:

FIG. 1 shows a schematic example of a lighting fixture, consistent with embodiments of the present disclosure.

FIG. 2 shows a perspective bottom view of an example of a ceiling mounted lighting fixture, consistent with embodiments of the present disclosure.

FIG. 3 shows a perspective top view of the ceiling mounted lighting fixture of FIG. 2, consistent with embodiments of the present disclosure.

FIG. 4 shows a cross-sectional view of the ceiling mounted lighting fixture of FIG. 2 taken generally along the line IV-IV of FIG. 2, consistent with embodiments of the present disclosure.

FIG. 5 shows a perspective view of a ceiling mounted lighting fixture, consistent with embodiments of the present disclosure.

FIG. 6 shows another cross-sectional view of the ceiling mounted lighting fixture of FIG. 2 taken generally along the line IV-IV of FIG. 2, consistent with embodiments of the present disclosure.

FIG. 7 shows a thermal diagram of an example of a ceiling mounted lighting fixture, consistent with embodiments of the present disclosure.

FIG. 8 shows a thermal diagram of an example of a ceiling mounted lighting fixture, consistent with embodiments of the present disclosure.

FIG. 9 shows a thermal diagram of an example of a ceiling mounted lighting fixture, consistent with embodiments of the present disclosure.

FIG. 10 shows a thermal diagram of an example of a ceiling mounted lighting fixture, consistent with embodiments of the present disclosure.

FIG. 11 shows a schematic example of a lighting fixture, consistent with embodiments of the present disclosure.

FIG. 12 shows a perspective view of a lighting fixture, consistent with embodiments of the present disclosure.

FIG. 13 shows a cross-sectional view of the lighting fixture of FIG. 12, consistent with embodiments of the present disclosure.

FIG. 14 shows a partial exploded view of a portion of the lighting fixture of FIG. 12, consistent with embodiments of the present disclosure.

FIG. 14A shows a perspective view of an example of the lighting fixture of FIG. 12, wherein an orientation of lighting segments of the lighting fixture has been transition to be an upward orientation, consistent with embodiments of the present disclosure.

FIG. 14B shows a perspective cross-sectional view of a portion of the lighting fixture of FIG. 12, consistent with embodiments of the present disclosure.

FIG. 14C shows a partial exploded view of a portion of a lighting fixture, consistent with embodiments of the present disclosure.

FIG. 15 shows a perspective view of an example of a lighting fixture, consistent with embodiments of the present disclosure.

FIG. 16 shows a perspective view of an example of a lighting fixture, consistent with embodiments of the present disclosure.

FIG. 17 shows a cross-sectional view of the lighting fixture of FIG. 15, consistent with embodiments of the present disclosure.

FIG. 18 shows a perspective view of an example of the lighting fixture of FIG. 12, consistent with embodiments of the present disclosure.

### DETAILED DESCRIPTION

The present disclosure is generally directed to a lighting fixture. The lighting fixture may include a frame, a light source coupled to the frame, and a driver electrically coupled to the light source. The light source may include a first lighting segment and a second lighting segment spaced apart from the first lighting segment. The driver may be positioned between the first and second lighting segments such that heat generated by the driver, the first light segment, and the second light segment generate a convective airflow. The convective airflow provides cooling to the driver and the light sources.

In some instances, three lighting segments may be used, wherein the driver is disposed above a central lighting segment. Such a configuration may allow for the size of the lighting fixture to be reduced, the driver to be positioned at a location that does not interfere with illumination, and/or reduce an amount of glare by increasing an overall surface area of light coverings (e.g., lenses). In some instances, positioning the driver over the central lighting segment may obscure the driver from the view of a user when looking upwards towards the lighting fixture. Such a configuration may improve the overall aesthetic appearance of the lighting fixture.

In some instances, the lighting fixture may be configured such that the driver is centrally located between two immediately adjacent lighting segments of the lighting fixture. In these instances, the driver includes a driver housing that is configured to encourage a convective airflow that flows over the driver and adjacent lighting segments. Such a configuration may improve the efficiency of the passive cooling while exposing the driver housing to view.

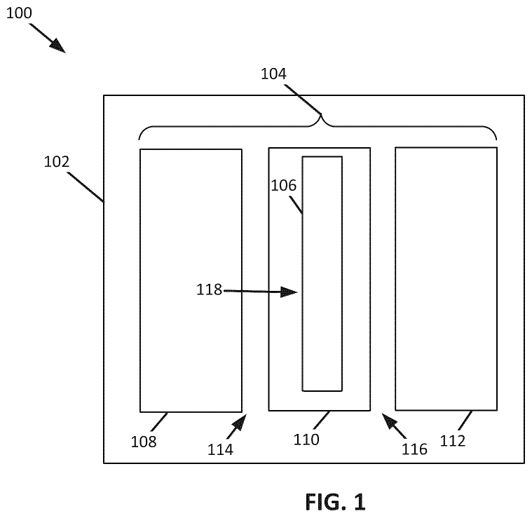

FIG. 1 shows a schematic example of a lighting fixture 100. The lighting fixture 100 includes a frame 102, a light source 104 coupled to the frame 102, and a driver 106 electrically coupled to the light source 104. As shown, the light source 104 may include a first lighting segment 108, a second lighting segment 110, and a third lighting segment 112, wherein the second lighting segment 110 is disposed between the first and third lighting segments 108 and 112. In some instances, the second lighting segment 110 may generally be described as being a central lighting segment and the first and third lighting segments may be generally described as lateral lighting segments. As shown, the first lighting segment 108 may be spaced apart from the second lighting segment 110 such that a first gap 114 extends therebetween and the third lighting segment 112 may be spaced apart from the second lighting segment 110 such that a second gap 116 extends therebetween. Each of the gaps 114 and 116 are configured such that air flows therethrough.

The driver 106 may be mounted at a position above the second lighting segment 110 such that the driver 106 is at least partially disposed between the first and second gaps 114 and 116. The driver 106 is configured to provide power to each of the first, second, and third lighting segments 108, 110, and 112. During operation, air flows through the first and second gaps 114 and 116 and along an exterior surface 118 of the driver 106. As air flows along the exterior surface 118 of the driver 106, heat generated by the driver 106 is absorbed by the air. In some instances, heat generated as a result of operation of the light source 104 and the driver 106 may encourage a convective air flow through the first and second gaps 114 and 116. Such a configuration may encourage a passive cooling of the light source 104 and/or the driver 106.

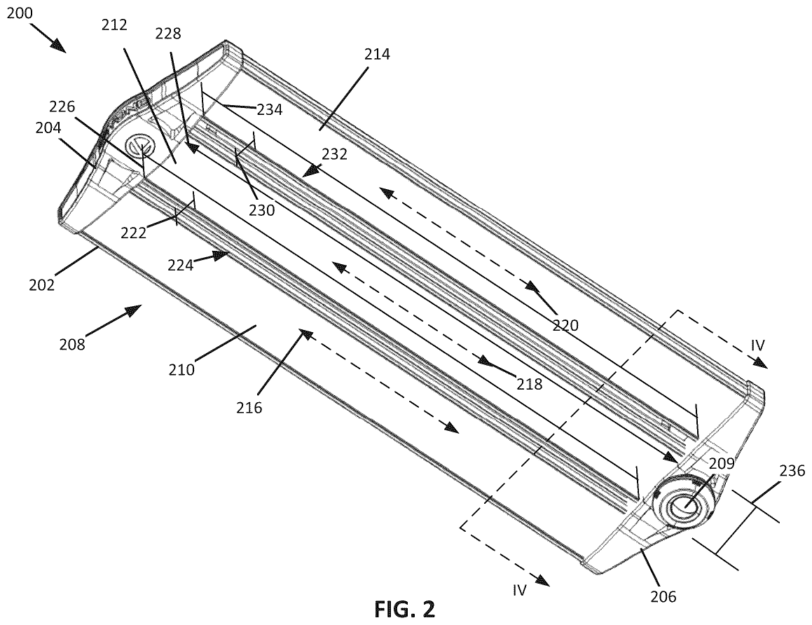

FIG. 2 shows a perspective bottom view of a ceiling mounted lighting fixture 200, which is an example of the lighting fixture 100 of FIG. 1. As shown, the ceiling mounted lighting fixture 200 includes a frame 202 having first and second end caps 204 and 206 and a light source 208 coupled to the frame 202 and extending between the first and second end caps 204 and 206. One or more sensors 209 may be coupled to the frame 202 (e.g., to at least one of first and/or second end caps 204 and/or 206). The one or more sensors 209 may be configured to detect one or more environmental conditions (e.g., ambient light, occupancy, motion, and/or the like).

The light source 208 includes a first lighting segment 210, a second lighting segment 212, and a third lighting segment 214, wherein the second lighting segment 212 is disposed between the first and third lighting segments 210 and 214. The first, second, and third lighting segments 210, 212, and 214 extend between the first and second end caps 204 and 206. For example, each of the first, second, and third lighting segments 210, 212, and 214 may have a corresponding lighting longitudinal axis 216, 218, and 220 that intersects with each of the first and second end caps 204 and 206, wherein the lighting longitudinal axes 216, 218, and 220 extend substantially (e.g., within 1° of, 2° of, 3° of, 4° of, or 5° of) parallel to each other.

The first lighting segment 210 is spaced apart from the second lighting segment 212 by a first separation distance 222, defining a first gap 224 between the first and second lighting segments 210 and 212. The first gap 224 extends in a direction substantially parallel to the lighting longitudinal axes 216, 218, and 220. The first gap 224 extends between the first and second end caps 204 and 206. For example, the first gap 224 may have a first gap length 226 that is substantially equal to a second lighting segment length 228. The second lighting segment length 228 generally corresponds to a portion of the second lighting segment 212 that is exposed within the frame 202. In other words, the second lighting segment length 228 may generally be described as the portion of the second lighting segment 212 that is disposed between the end caps 204 and 206 of the frame 202.

The third lighting segment 214 is spaced apart from the second lighting segment 212 by a second separation distance 230, defining a second gap 232 between the second and third lighting segments 212 and 214. The second gap 232 extends in a direction substantially parallel to the lighting longitudinal axes 216, 218, and 220. The second gap 232 extends between the first and second end caps 204 and 206. For example, the second gap 232 may have a second gap length 234 that is substantially equal to the second lighting segment length 228.

The first and second separation distances 222 and 230 may be configured such that a convective flow of air passing through the first and second gaps 224 and 232 is encouraged to be laminar. In some instances, the first and second separation distances 222 and 230 may be in a range of 0.6 centimeter (cm) to 1 cm.

As shown, the second lighting segment length 228 is greater than a second lighting segment width 236. For example, the second lighting segment length 228 may be at least two times greater than the second lighting segment width 236. The first and third lighting segments 210 and 214 may have a length substantially the same as that of the second lighting segment 212.

Each of the first, second, and third lighting segments 210, 212, and 214 may include a plurality of light emitting diodes (LEDs). Each of the first, second, and third lighting segments 210, 212, and 214 may be individually controlled such that the LEDs of one of the lighting segments 210, 212, or 214 may be controlled differently from the LEDs of at least one other of the lighting segments 210, 212, or 214.

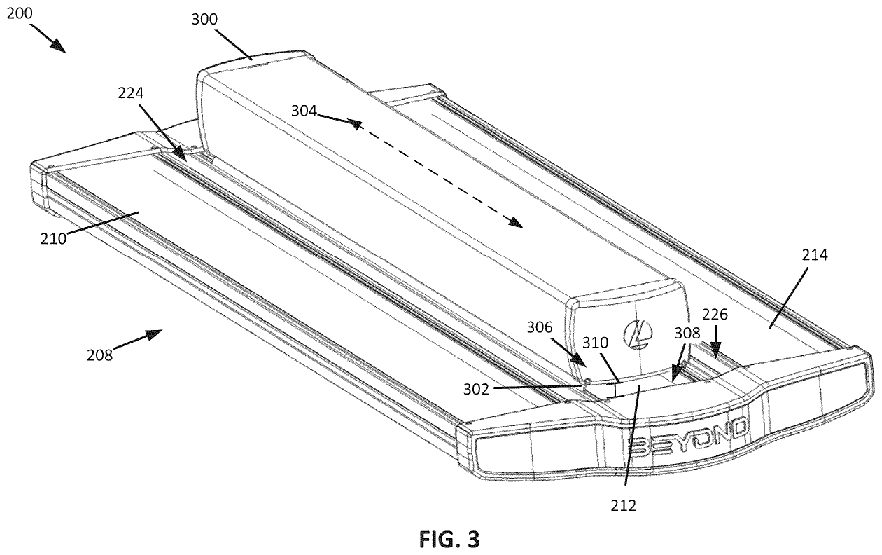

FIG. 3 shows a top perspective view of the ceiling mounted lighting fixture 200. As shown, the ceiling mounted lighting fixture 200 includes a driver 300 configured to provide power to the light source 208 such that each of the first, second, and third lighting segments 210, 212, and 214 are illuminated. The driver 300 may be configured to vary the power supplied to one or more of first, second, and third lighting segments 210, 212, and 214 such that an intensity of the generated light can be adjusted.

As shown, the driver 300 is disposed between the first and third lighting segments 210 and 214 and above the second lighting segment 212. For example, the driver 300 may include mounting features 302 configured to engage the second lighting segment 212, coupling the driver 300 with the second lighting segment 212. The driver 300 may be positioned such that the driver 300 extends, at least partially (e.g., entirely), between the first and second gaps 224 and 232. A driver longitudinal axis 304 may extend substantially parallel to the lighting longitudinal axes 216, 218, and 220.

A bottom portion 306 of the driver 300 may be spaced apart from a top portion 308 of the second lighting segment 212 by a driver-source separation distance 310. The top portion 308 may generally be referred to as the portion facing away from a room to be illuminated. The driver-source separation distance 310 may be, for example, in a range of 0.6 cm to 2 cm. By way of further example, the driver-source separation distance may be about (e.g., within 10% of, 5% of, 4% of, 3% of, 2% of, or 1% of) 1.27 cm. The driver-source separation distance 310 may be configured to at least partially thermally isolate (e.g., reduce heat transfer, relative to direct contact, by at least 5%, at least 10%, at least 20%, at least 30%, at least 40%, at least 50%, or at least 75%) the driver 300 from the second lighting segment 212. Additionally, or alternatively, the mounting features 302 may be configured to at least partially thermally isolate the driver 300 from the second lighting segment 212 (e.g., the mounting features 302 may include a thermally insulating material).

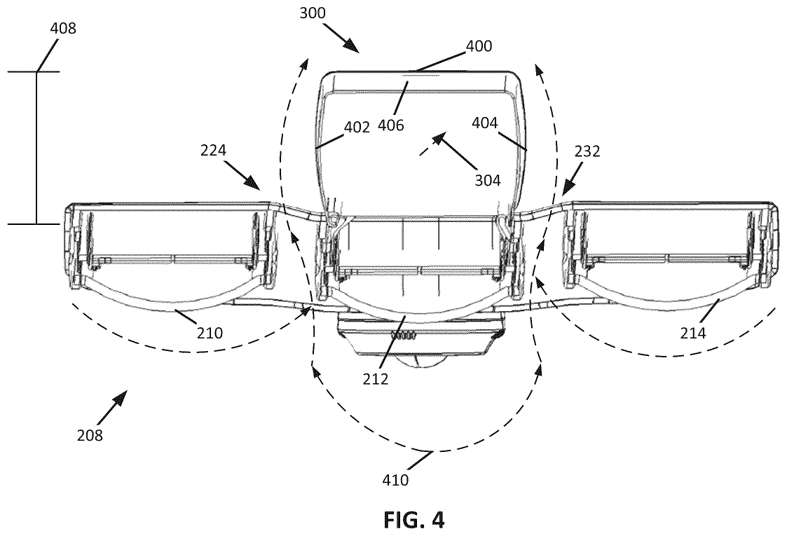

FIG. 4 shows a cross-sectional perspective view of the ceiling mounted lighting fixture 200 taken generally along the line IV-IV of FIG. 2. The components within the driver 300 and the first, second, and third lighting segments 210, 212, and 214 have been omitted for the sake of clarity.

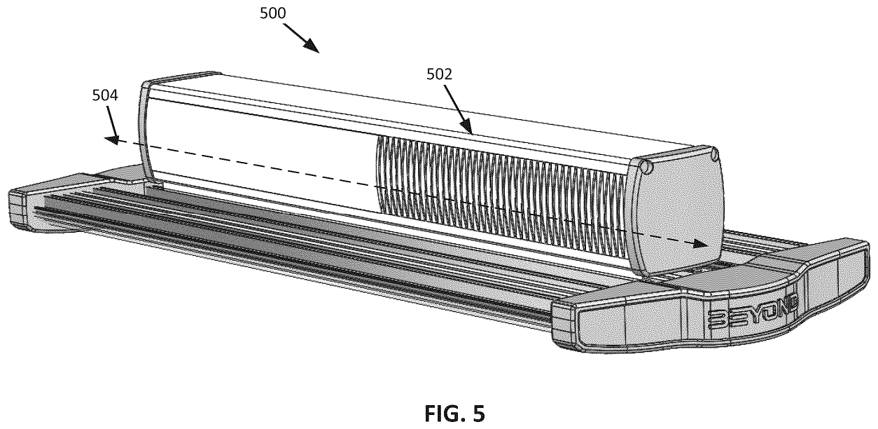

As shown, the driver 300 includes a driver housing 400. The driver housing 400 may be formed through an extrusion process. The driver housing 400 includes at least a first sidewall 402, a second sidewall 404, and a connecting wall 406 extending between the first and second sidewalls 402 and 404. The first and second sidewalls 402 and 404 may have a convex shape that extends along and opens in a direction of the driver longitudinal axis 304. For example, the convex shape may include an arcuate shape that extends for at least a portion of a driver height 408 of the driver 300. The convex shape of the first and second sidewalls 402 and 404 causes a portion of the first and second sidewalls 402 and 404 to protrude outwardly in a direction of the first and second gaps 224 and 232, respectively. Additionally, or alternatively, the first and/or second sidewalls 402 may include heat dissipation fins (see, e.g., FIG. 5 showing an example of a driver 500 that includes heat dissipation fins 502 that extend transverse to a driver longitudinal axis 504 in a direction of airflow, wherein the heat dissipation fins 502 may be formed through, for example, extrusion or die casting).

The first and second gaps 224 and 232 are positioned such that air, flowing along an airflow path 410, flows along the first and second sidewalls 402 and 404 of the driver housing 400. The convex shape of the first and second sidewalls 402 and 404 increases a path length of the airflow path 410 along the first and second sidewalls 402 and 404 (relative to planar sidewalls). Increasing the path length along the first and second sidewalls 402 and 404 may increase heat dissipation from the driver 300. The convex shape of the first and second sidewalls 402 and 404 may further encourage air flowing along the airflow path 410 to remain a laminar flow.

A flow of air along the airflow path 410 may be encouraged as a result of convection. In other words, heat generated by the driver 300 and/or the light source 208 may be absorbed by adjacent air, causing the air to rise, generating a convective current of air that moves along the airflow path 410. The first and second gaps 224 and 232 may be configured to encourage air flowing along the airflow path 410 to be laminar (e.g., for a majority of the airflow path 410 used for cooling the driver 300 and/or the light source 208). Use of a convective flow may, for example, allow a cooling fan to be omitted.

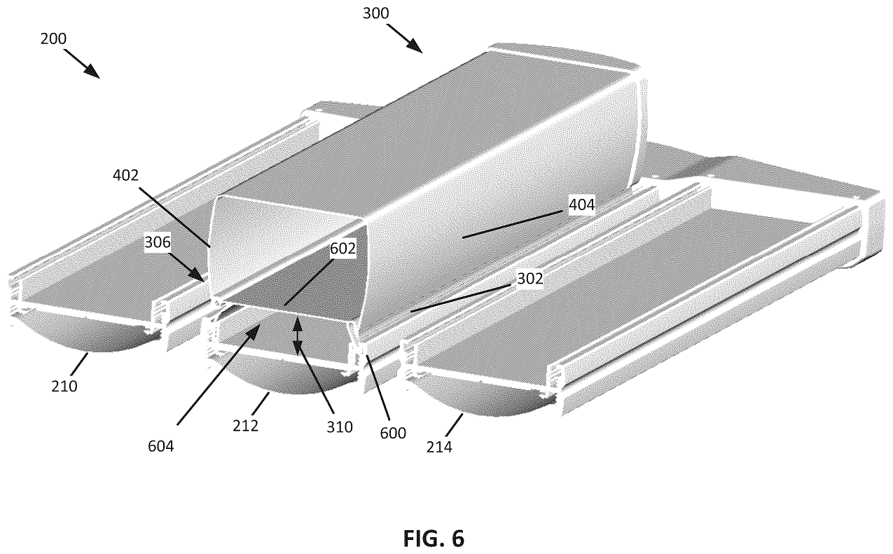

FIG. 6 shows another cross-sectional perspective view of the ceiling mounted lighting fixture 200 taken generally along the line IV-IV of FIG. 2. The components within the driver 300 and the first, second, and third lighting segments 210, 212, and 214 have been omitted for the sake of clarity.

As shown, the mounting features 302 may be configured to cooperate with corresponding rails 600 of the second lighting segment 212. The mounting features 302 extend from the bottom portion 306 of the driver 300. In some instances, the mounting features 302 may extend from a base plate 602. The base plate 602 may be configured to couple to the driver housing 400. For example, the base plate 602 may couple (e.g., pivotally) with the first and/or second sidewalls 402 and/or 404. In some instances, the base plate 602 may be separable from the driver housing 400 and/or pivotally coupled to the driver housing 400 such that one or more electrical components of the driver 300 may be accessed (e.g., for repair or replacement). For example, the ceiling mounted lighting fixture 200 may be configured such that the driver 300 may be accessed (e.g., for repair or replacement) while remaining installed in a facility (e.g., a building). In this example, the ceiling mounted lighting fixture 200 may not need to be uninstalled from the facility for maintenance.

As also shown, a channel 604 may be defined between the base plate 602 and the second lighting segment 212, wherein a height of the channel 604 is defined by the driver-source separation distance 310. The channel 604 may extend for the full length of the driver 300. Air within the channel 604 may at least partially thermally isolate the driver 300 from the second lighting segment 212.

One or more of the electrical components of the driver 300 may be in contact with (e.g., direct contact with) one or more of the first and/or second sidewalls 402 and/or 404. As such, heat generated by the one or more electrical components may be more efficiently conducted to the first and/or second sidewalls 402 and/or 404. As such air flowing over the first and/or second sidewalls 402 and/or 404 may more efficiently remove heat from the one or more electrical components of the driver 300.

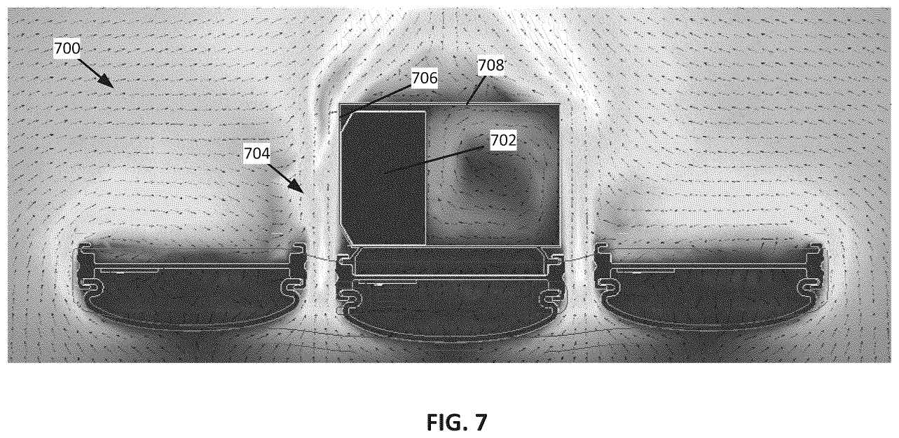

FIG. 7 shows a thermal diagram of an example of a ceiling mounted lighting fixture 700 which is an example of the lighting fixture 100 of FIG. 1. As shown, one or more electrical components 702 of a driver 704 are mounted to a first sidewall 706 of a driver housing 708. Such a configuration may encourage heat dissipation as air flows along the first sidewall 706. As shown, the first sidewall 706 is substantially planar and is oriented to be substantially upright.

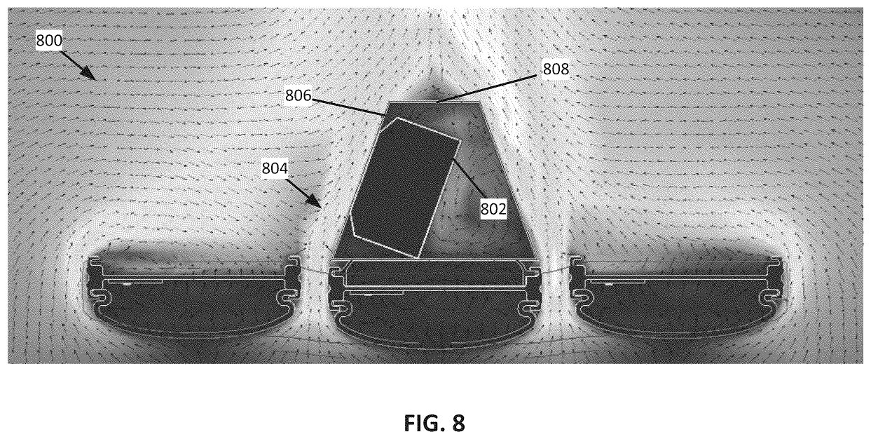

FIG. 8 shows a thermal diagram of an example of a ceiling mounted lighting fixture 800 which is an example of the lighting fixture 100 of FIG. 1. As shown, one or more electrical components 802 of a driver 804 are mounted to a first sidewall 806 of a driver housing 808. Such a configuration may encourage heat dissipation as air flows along the first sidewall 806. As shown, the first sidewall 806 is substantially planar and is angled (e.g., inwardly) relative to a substantially upright position.

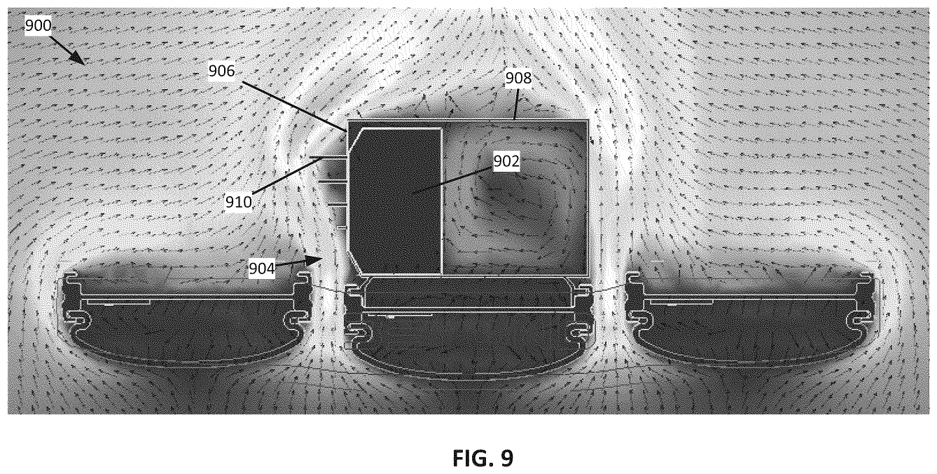

FIG. 9 shows a thermal diagram of an example of a ceiling mounted lighting fixture 900 which is an example of the lighting fixture 100 of FIG. 1. As shown, one or more electrical components 902 of a driver 904 are mounted to a first sidewall 906 of a driver housing 908, wherein the first sidewall 906 includes one or more heat dissipation fins 910 formed via an extrusion process. Such a configuration may encourage heat dissipation as air flows along the first sidewall 906. As shown, the first sidewall 906 is substantially planar and substantially upright.

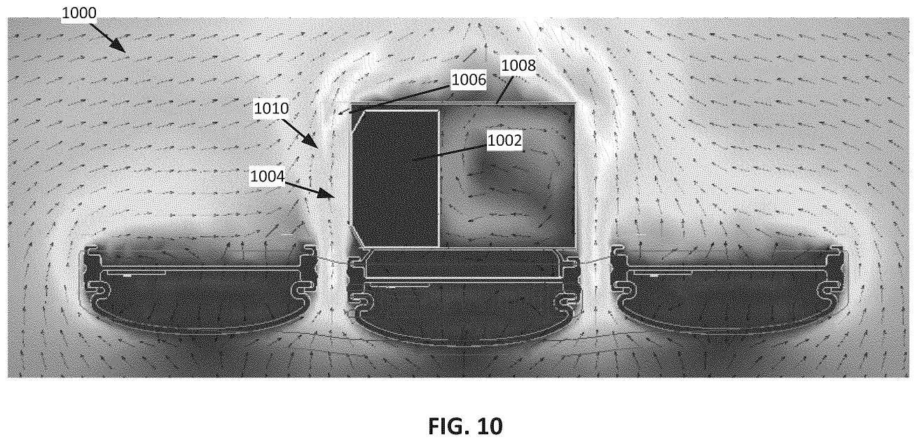

FIG. 10 shows a thermal diagram of an example of a ceiling mounted lighting fixture 1000 which is an example of the lighting fixture 100 of FIG. 1. As shown, one or more electrical components 1002 of a driver 1004 are mounted to a first sidewall 1006 of a driver housing 1008, wherein the first sidewall 1006 includes one or more heat dissipation fins 1010 formed via a die casting process. Such a configuration may encourage heat dissipation as air flows along the first sidewall 1006. As shown, the first sidewall 1006 is substantially planar and substantially upright.

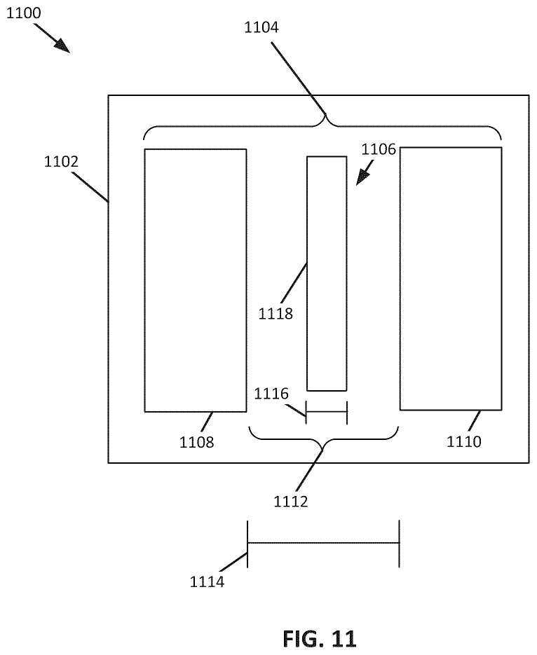

FIG. 11 shows a schematic example of a lighting fixture 1100. The lighting fixture 1100 includes a frame 1102, a light source 1104 coupled to the frame 1102, and a driver 1106 coupled to the frame 1102 and electrically coupled to the light source 1104. As shown, the light source 1104 includes a first lighting segment 1108 and a second lighting segment 1110. The first lighting segment 1108 and the second lighting segment 1110 are spaced apart from each other such that a gap 1112 extends between the first and second lighting segments 1108 and 1110. The gap 1112 has a gap width 1114. The driver 1106 is disposed between the first and second lighting segments 1108 and 1110. The gap width 1114 may be greater than at least a portion of a driver width 1116 of the driver 1106. For example, at least a portion of the driver 1106 may be disposed within the gap 1112.

In operation, each of the lighting segments 1108 and 1110 and the driver 1106 generate heat. The generated heat causes a convective airflow to move through the gap 1112 and flow over a portion of each of the lighting segments 1108 and 1110 and the driver 1106, passively cooling each of the lighting segments 1108 and 1110 and the driver 1106. In some instances, the driver 1106 may include a driver housing 1118 configured to encourage the convective airflow to provide passive cooling (e.g., by splitting the airflow, encouraging turbulence, encourage airflow velocity changes, and/or the like).

In some instances, the frame 1102 may be configured to encourage passive the cooling of the lighting segments 1108 and 1110 and the driver 1106. For example, the frame 1102 may be configured to allow air to pass through the frame 1102 over the lighting segments 1108 and 1110 and/or into the gap 1112. In this way, an increased airflow and/or additional airflow directions over each of the lighting segments 1108 and 1110 and/or the driver 1106 may be provided.

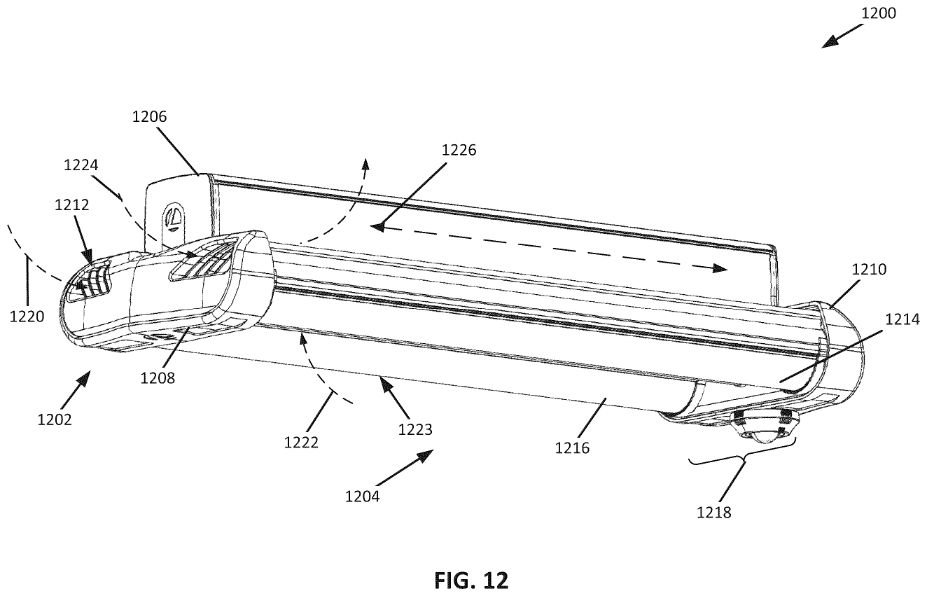

FIG. 12 shows a perspective view of a lighting fixture 1200 (e.g., a ceiling mounted lighting fixture), which is an example of the lighting fixture 1100 of FIG. 11. As shown the lighting fixture 1200 includes a frame 1202, a light source 1204 coupled to the frame 1202, and a driver 1206 coupled to the frame 1202 and electrically coupled to the light source 1204. As shown, the frame 1202 includes endcaps 1208 and 1210 disposed at opposing ends of the light source 1204. The endcaps 1208 and 1210 include airflow openings 1212 through which air can pass and are configured provide a consistent aesthetic appearance on opposing ends of the light source 1204 (e.g., by obscuring at least a portion of one or more of the light source 1204 and/or the driver 1206 from view).

The light source 1204 includes a first lighting segment 1214 and a second lighting segment 1216. The first lighting segment 1214 is spaced apart from the second lighting segment 1216 by a gap 1218. The driver 1206 is coupled to the frame 1202. The driver 1206 is disposed between the first and second lighting segments 1214 and 1216 such that air can flow into the gap 1218 and along at least a portion of the driver 1206. At least a portion of the driver 1206 may be exposed through the gap 1218 (e.g., extend into the gap 1218).

During operation heat generated by the driver 1206 and the first and second lighting segments 1214 and 1216 causes air to flow along a first convective airflow path 1222, a second convective airflow path 1224, and a third convective airflow path 1220. The first convective airflow path 1222 enters the gap 1218 via a gap opening 1223. The first convective airflow path 1222 is configured to extend over at least a portion of the driver 1206. The gap opening 1223 is disposed below the driver 1206 and between the first and second lighting segments 1214 and 1216. The second convective airflow path 1224 passes through a first grouping of the airflow openings 1212 of at least one (e.g., both) of the endcaps 1208 and 1210 and extends over at least a portion of a respective light lighting segment 1214 or 1216. The third convective airflow path 1220 passes through a second grouping of the airflow openings 1212 of at least one (e.g., both) of the endcaps 1208 and 1210 and extends over at least a portion of a respective light lighting segment 1214 or 1216. In some instances, at least a portion of air flowing along each of the first, second, or third convective airflow paths 1222, 1224, and 1220 may converge within the gap 1218.

As shown, the second and third convective airflow paths 1224 and 1220 extend generally in a direction along a fixture longitudinal axis 1226 of the lighting fixture 1200 and the first convective airflow path 1222 extends in a direction generally transverse to (e.g., perpendicular to) the fixture longitudinal axis 1226. In some instances, one or more of the driver 1206, the first lighting segment 1214, and/or the second lighting segment 1216 may be configured to encourage an exchange of heat with the air flowing along a respective one of the first, second, or third convective airflow paths 1222, 1224, or 1220. For example, one or more of the driver 1206, the first lighting segment 1214, and/or the second lighting segment 1216 may be configured to encourage the development of a turbulent flow and/or introduce a velocity change to a flow of air.

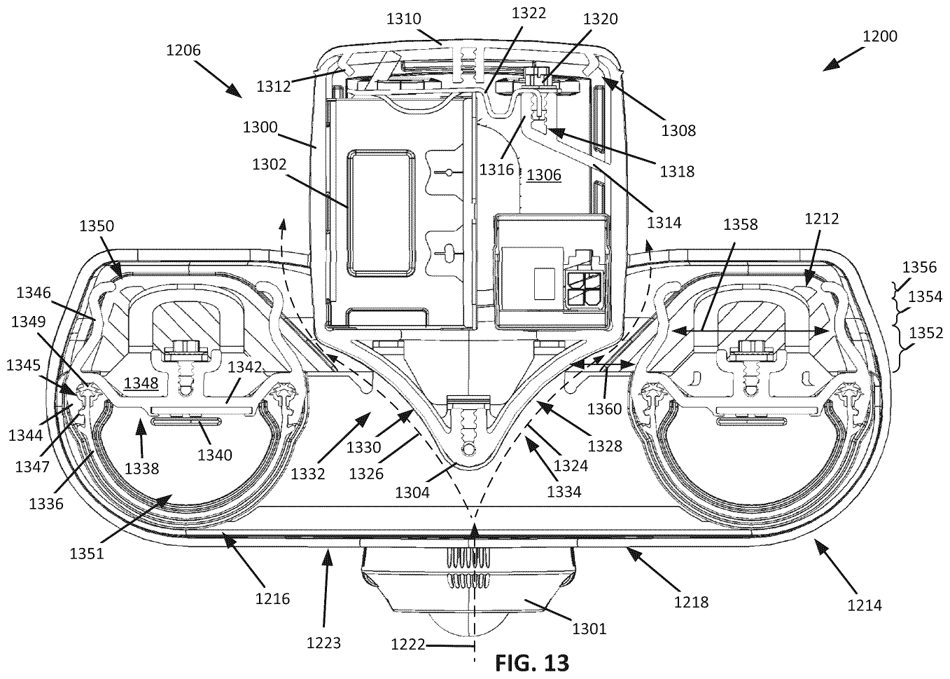

FIG. 13 shows a cross-sectional view of the lighting fixture 1200. As shown, the driver 1206 includes a driver housing 1300 and a power supply 1302 (e.g., configured to convert alternating current into direct current) electrically coupled to the light source 1204. At least a portion of the driver housing 1300 can be configured to extend into the gap 1218. The driver housing 1300 includes a deflector 1304 and a driver cavity 1306 having an open end 1308. The open end 1308 and the deflector 1304 may be disposed on opposing sides of the driver housing 1300. At least a portion of the deflector 1304 may be configured to extend into the gap 1218. The power supply 1302 can be disposed within the driver cavity 1306 such that at least a portion of two surfaces of the power supply 1302 are engaging (e.g., contacting) at least a portion of two surfaces (e.g., sidewalls) of the driver cavity 1306. Such a configuration may encourage heat transfer from the power supply 1302 to the driver housing 1300. The driver housing 1300 can be formed of a heat conductive material such as a metal alloy (e.g., an aluminum alloy, a copper alloy, a steel alloy, and/or any other metal alloy) and/or any other heat conductive material. In some instances, the lighting fixture 1200 may further include at least one sensor 1301, wherein a controller communicatively coupled to the sensor 1301 may be included within the driver cavity 1306. The sensor 1301 may be configured to detect one or more environmental conditions (e.g., ambient light, occupancy, motion, and/or the like).

A closure cap 1310 may be configured to couple (e.g., removably or non-removably) to the driver housing 1300 at the open end 1308 such that the closure cap 1310 closes (e.g., selectively) the driver cavity 1306. For example, and as shown, the closure cap 1310 may include connection arms 1312 that are configured to engage a corresponding portion of the driver housing 1300 (e.g., to form a reversible or non-reversible snap-fit connection) to couple the closure cap 1310 to the driver housing 1300.

As shown, the driver housing 1300 further includes a mounting arm 1314 that extends along at least a portion (e.g., an entirety) of a length of the driver housing 1300. The mounting arm 1314 extends into the driver cavity 1306 in a direction of the power supply 1302. The mounting arm 1314 may include a mounting fixture 1316 having a mounting channel 1318 extending therein. The mounting channel 1318 is configured to receive a fastener 1320 (e.g., a threaded fastener such as a bolt or a screw) such that one or more components may be coupled to the mounting arm 1314. For example, and as shown, the driver 1206 may include a power supply mounting bracket 1322 coupled to the mounting arm 1314 at the mounting fixture 1316. The power supply mounting bracket 1322 may be configured to encourage the power supply 1302 to engage (e.g., contact) one or more sides of the driver housing 1300. Such a configuration may encourage a more efficient transfer of heat from the power supply 1302 to the driver housing 1300. In some instances, the power supply mounting bracket 1322 may be configured to generate a spring bias that urges the power supply into at least one (e.g., a plurality of) surface of the driver housing 1300.

At least a portion of the deflector 1304 is configured to extend within the gap 1218 such that air flowing along the first convective airflow path 1222 is caused to split into a first branch 1324 and a second branch 1326. The first and second branches 1324 and 1326 are configured to extend along opposing sides of the driver housing 1300. As shown, the deflector 1304 includes a first flow surface 1328 and a second flow surface 1330. The first and second flow surfaces 1328 and 1330 extend towards the gap opening 1223 and converge towards each other in a direction of the gap opening 1223. In some instances, and as shown, each of the first and second flow surfaces 1328 and 1330 may include a corresponding arcuate portion 1332 and 1334. Each arcuate portion 1332 and 1334 may have a concave shape that opens in a direction of a respective lighting segment 1214 or 1216. Such a configuration causes air flowing along the first convective airflow path 1222 to be urged in a direction of a respective lighting segment 1214 and 1216. In this way, air flowing along the first branch 1324 provides cooling for the first lighting segment 1214 and air flowing along the second branch 1326 provides cooling for the second light segment 1216.

As shown, each lighting segment 1214 and 1216 includes a light cover 1336 (e.g., a diffuser or lens), a light mount 1338, and a light generator 1340 (e.g., one or more LEDs). As shown, the light cover 1336 and the light generator 1340 are coupled to the light mount 1338, wherein the light cover 1336 extends over at least a portion of the light generator 1340. The light cover 1336 is at least partially transparent to light emitted by the light generator 1340. The light mount 1338 includes a light generator platform 1342 to which the light generator 1340 is coupled, a cover connector 1344 extending from the light generator platform 1342 to which the light cover 1336 is coupled, and at least one (e.g., a plurality of) heat dissipation fin 1346 extending away from the light generator platform 1342 (e.g., extending from the cover connector 1344). The light cover connector 1344 defines a connection cavity 1345 including one or more connectors 1347 configured to engage with the light cover 1336 to couple the light cover 1336 to the light mount 1338. In some instances, and as shown, a cover gasket 1349 may be coupled to the light cover 1336 and be configured to sealingly engage with a closed end of the connection cavity 1345. Such a configuration may mitigate debris ingress into an emission cavity 1351 extending between the light cover 1336 and the light generator platform 1342.

The light mount 1338 is configured such that heat generated by the light generator 1340 is transferred to the light generator platform 1342 and into the heat dissipation fin 1346. As such, as air flowing along the first convective airflow path 1222 passes over the heat dissipation fin 1346, heat generated by the light generator 1340 may be absorbed by the air. The light mount 1338 can be formed of a heat conductive material such as a metal alloy (e.g., an aluminum alloy, a copper alloy, a steel alloy, and/or any other metal alloy) and/or any other heat conductive material.

As further shown, each light mount 1338 includes a plurality of heat dissipation fins 1346 disposed on opposing sides of the light generator platform 1342. Each of the plurality of heat dissipation fins 1346 cooperate to form a dissipation cavity 1348 extending between the plurality of heat dissipation fins 1346. The dissipation cavity 1348 includes a dissipation cavity open end 1350 opposite the light generator platform 1342. At least a portion of the heat transferred to the light generator platform 1342 from the light generator 1340 is transferred to air moving along a respective one of the second or third convective airflow paths 1224 or 1220 (FIG. 12). As the air moves along the second and third convective airflow paths 1224 and 1220 into the dissipation cavity 1348, at least a portion of the heated air exits the dissipation cavity 1348 via the dissipation cavity open end 1350.

Each of the heat dissipation fins 1346 of a corresponding light mount 1338 can be configured to cooperate to encourage heat transfer. For example, and as shown, the dissipation cavity 1348 can include a first cavity contraction region 1352, a first cavity expansion region 1354, and a second cavity contraction region 1356, wherein the first cavity expansion region 1354 is disposed between the first and second cavity contraction regions 1352 and 1356 and the second cavity contraction region 1356 is disposed between the dissipation cavity open end 1350 and the first cavity expansion region 1354 and the first cavity contraction region 1352. As shown, a fin separation distance 1358 extending between heat dissipation fins 1346 of a corresponding light mount 1338 decreases within the cavity contraction regions 1352 and 1356 and increases within the first cavity expansion region 1354. In some instances, and as shown, each of the heat dissipation fins 1346 may include arcuate regions (e.g., to form a serpentine shape). Each of the arcuate regions may cooperate to form the cavity contraction and expansion regions 1352, 1354, and 1356. The changes in the fin separation distance 1358 may introduce changes in a velocity of air and/or cause a turbulent flow of air. Such a configuration may encourage heat transfer.

The heat dissipation fins 1346 immediately adjacent the driver 1206 can be configured to cooperate with the driver housing 1300 to encourage heat transfer from the driver housing 1300 to air flowing along the first convective airflow path 1222. For example, a housing-fin separation distance 1360 extending between the driver housing 1300 and a respective immediately adjacent heat dissipation fin 1346 may vary (e.g., continuously) along a length of heat dissipation fin 1346. In this example, the housing-fin separation distance 1360 may first decrease before increasing. After increasing, the housing-fin separation distance 1360 may then decrease and then subsequently increase again for the remainder of a length of the heat dissipation fin 1346. Varying the housing-fin separation distance 1360 may introduce changes in a velocity of air and/or cause a turbulent flow of air. Such a configuration may encourage heat transfer.

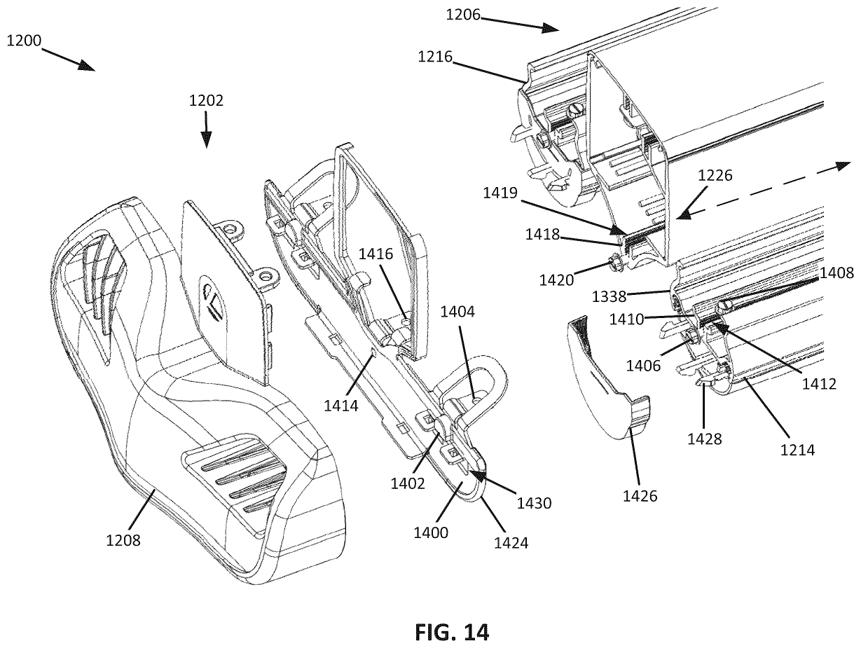

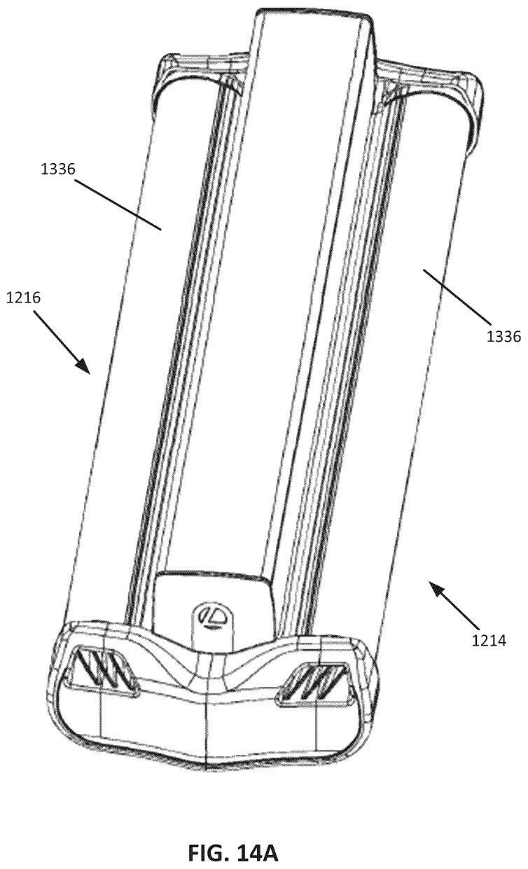

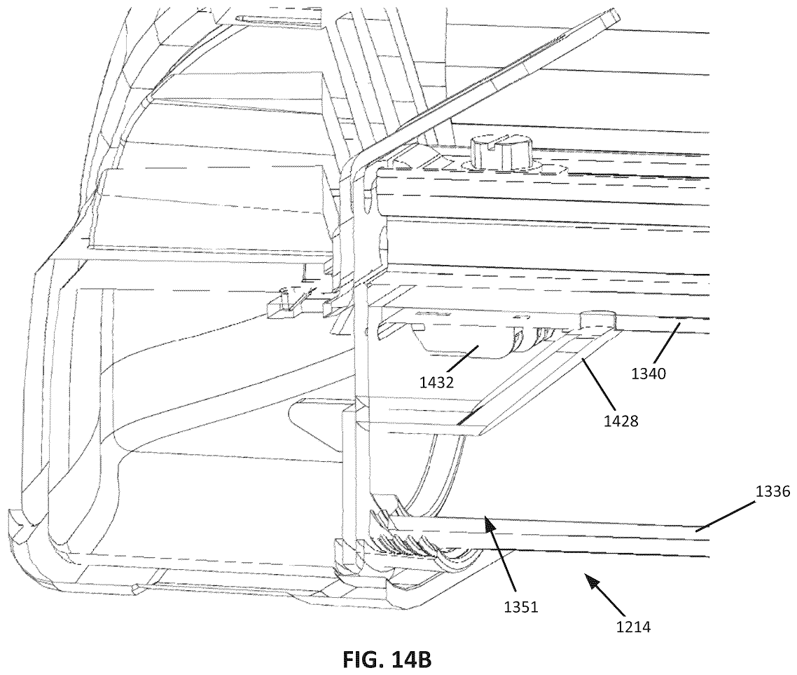

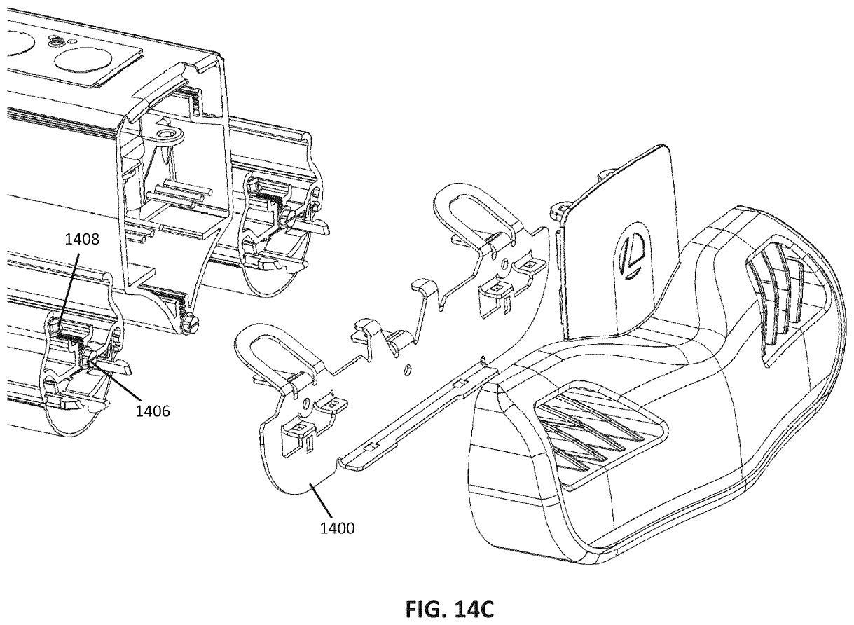

FIG. 14 shows a partial exploded view of one end of the lighting fixture 1200. While only one end is shown, a substantially similar configuration is found at the opposing end and the discussion of such is omitted for the sake of brevity. As shown, the frame 1202 includes a mounting bracket 1400. At least a portion of the mounting bracket 1400 is disposed between at least a portion of the endcap 1208, at least a portion of the driver 1206, and at least a portion the first and second lighting segments 1214 and 1216. The mounting bracket 1400 is configured to couple to each of the first and second lighting segments 1214 and 1216 and to the driver 1206. For example, and as shown, the mounting bracket 1400 includes a plurality of axial light mounts 1402 and a plurality of transverse light mounts 1404, wherein at least one axial light mount 1402 and at least one transverse light mount 1404 corresponds to a respective lighting segment 1214 and 1216. Each axial light mount 1402 is configured to receive a corresponding axial light fastener 1406 (e.g., a threaded fastener such as a bolt or a screw) and each transverse light mount 1404 is configured to receive a corresponding transverse light fastener 1408 (e.g., a threaded fastener such as a bolt or a screw).

Each axial light fastener 1406 extends substantially parallel to the fixture longitudinal axis 1226 and is configured to couple to the light mount 1338. Each transverse light fastener 1408 extends transverse to (e.g., perpendicular to) the fixture longitudinal axis 1226 and is configured to couple to the light mount 1338. As shown, the light mount 1338 includes a light mounting track 1410 that includes a light mounting groove 1412 for receiving (e.g., threadably) the axial and transverse light fasteners 1406 and 1408. The light mounting track 1410 may extend continuously along the full length of the light mount 1338.

Removal of only the transverse light fasteners 1408 may allow for the rotation of the lighting segments 1214 and 1216 about each of the axial light fasteners 1406. Such a configuration may allow for the emission direction of each of the lighting segments 1214 and 1216 to be adjusted. For example, the lighting segments 1214 and 1216 may be adjusted from pointing downwardly (see, e.g., FIG. 14) to upwardly (see, e.g., FIG. 14A).

In some instances, the transverse light mounts 1404 may be configured to be moved (e.g., through permanent or non-permanent deformation) to allow for the free rotation of the lighting segments 1214 and 1216. When adjusting one or more of the lighting segments 1214 and/or 1216, additional coupling points may be provided to retain the lighting segments 1214 and/or 1216 in the adjusted position. Additionally, or alternatively, a different mounting bracket 1400 may be provided, wherein the location of the transverse light mounts 1404 has been adjusted.

As shown, the mounting bracket 1400 further includes an axial driver mount 1414 and a transverse driver mount 1416. The driver housing 1300 includes a driver mounting track 1418 having a driver groove 1419 that is configured to receive (e.g., threadably) a corresponding axial driver fastener 1420 (e.g., a threaded fastener such as a bolt or a screw) and transverse driver fastener (e.g., a threaded fastener such as a bolt or a screw) to couple the driver 1206 to the mounting bracket 1400.

As shown, a gasket 1424 is configured to be disposed between at least a portion of the endcap 1208 and/or the mounting bracket 1400. When assembled, the gasket 1424 is configured to discourage an ingress of debris (e.g., dust) into the driver cavity 1306. Additionally, or alternatively, lighting segment endcaps 1426 may be configured to be coupled to distal ends of a respective lighting segment 1214 and 1216. The lighting segment endcaps 1426 are configured to discourage an ingress of debris (e.g., dust) into the lighting segments 1214 and 1216.

As further shown, an electrical connector cover 1428 may be configured to couple to the mounting bracket 1400. For example, the mounting bracket 1400 may include cover openings 1430 configured to form a snap-fit connection with the electrical connector cover 1428. In this way, a position of the electrical connector cover 1428 within the light segments 1214 and 1216 is fixed. When assembled, a portion of the electrical connector cover 1428 extends through the lighting segment endcap 1426 to engage with the cover openings 1430. With additional reference to FIG. 14B, the electrical connector cover 1428 is configured to be received within a respective lighting segment 1214 or 1216 (e.g., within a respective emission cavity 1351) and to extend over electrical connectors 1432 configured to provide electrical power to the light generator 1340. Such a configuration may improve electrical shock resistance (e.g., when the light cover 1336 is removed) and/or fire resistance. The electrical connector cover 1428 may be provided at only one side of the lighting fixture 1200 or on both sides of the lighting fixture 1200 (e.g., depending on whether electrical connectors 1432 are on only one side or both sides of the lighting fixture 1200).

In some instances, one or more of the gasket 1424 and/or the lighting segment endcaps 1426 may be omitted. For example, FIG. 14C shows an example in which the gasket 1424 and the light segment endcaps 1426 have been omitted.

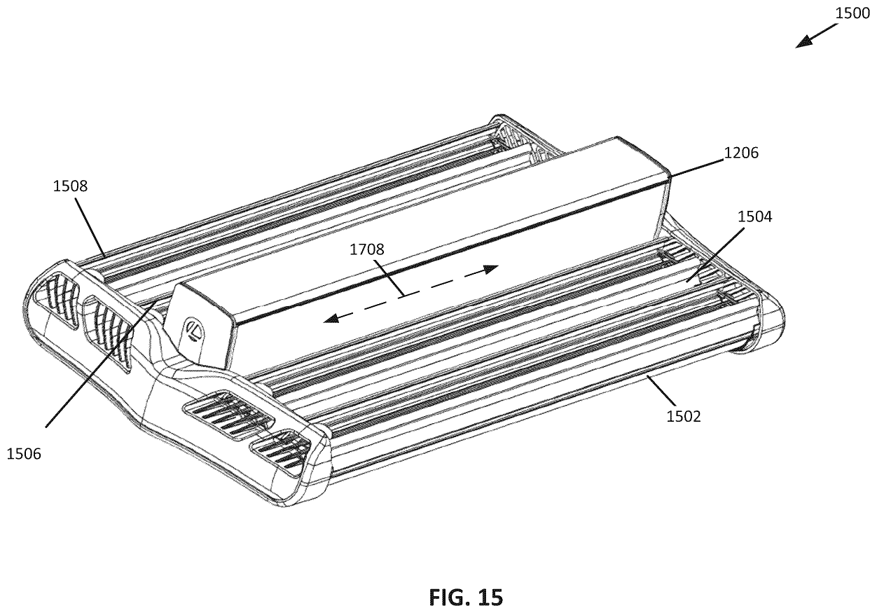

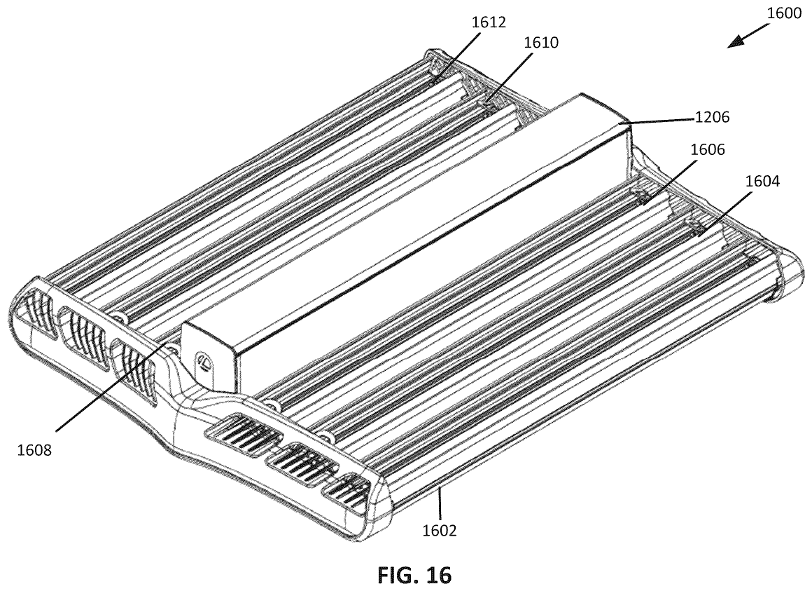

While the lighting fixture 1200 is shown as having two lighting segments 1214 and 1216, other configurations are possible. For example, FIG. 15 shows an example lighting fixture 1500 having four lighting segments 1502, 1504, 1506, and 1508, wherein the driver 1206 is centrally disposed between the four lighting segments 1502, 1504, 1506, and 1508. By way of further example, FIG. 16 shows an example lighting fixture 1600 having six lighting segments 1602, 1604, 1606, 1608, 1610, and 1612, wherein the driver 1206 is centrally disposed between the six lighting segments 1602, 1604, 1606, 1608, 1610, and 1612. Additionally, or alternatively, the lighting fixtures disclosed herein (e.g., lighting fixtures 100, 200, 700, 800, 900, 1000, 1100, 1200, 1500, and/or 1600) may have any length. For example, any one or more of the lighting fixtures disclosed herein may have a length of about (e.g., within 10% of, 5% of, 4% of, 3% of, 2% of, or 1% of) 0.6 meter (m), about 1.2 m, about 1.8 m, about 2.4 m, about 3.0 m, about 3.7 m, or any other length.

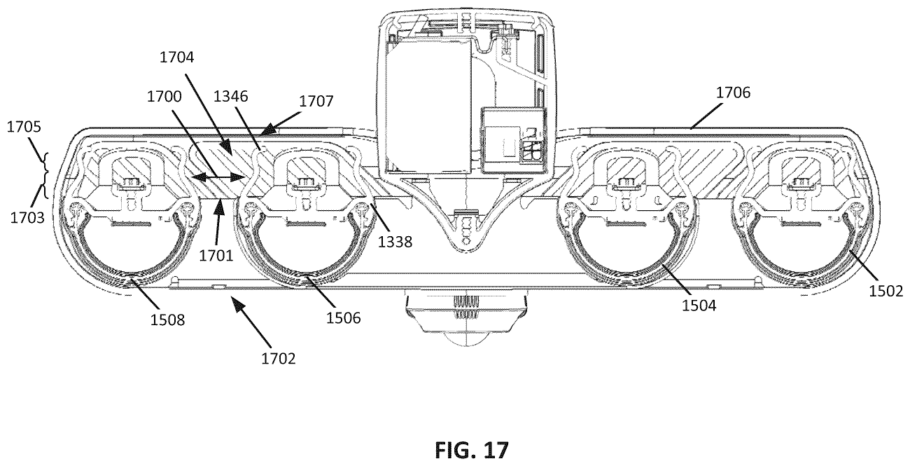

FIG. 17 shows a cross-sectional view of the lighting fixture 1500 of FIG. 15. As shown, each of the lighting segments 1502, 1504, 1506, and 1508 include the light mount 1338. The light mounts 1338 of immediately adjacent lighting segments of the lighting segments 1502, 1504, 1506, and 1508 can be configured to encourage heat dissipation. For example, immediately adjacent heat dissipation fins 1346 may cooperate to form a dissipation channel 1701 extending therebetween, wherein a dissipation channel width (or adjacent fin separation distance) 1700 varies (e.g., continuously) along a length of the heat dissipation fins 1346. Such a configuration may introduce changes in a velocity and/or turbulence to air flowing therebetween, which may improve heat transfer from the heat dissipation fins 1346 to the flow of air.

The dissipation channel 1701 may have at least at least one channel expansion region 1703 in which the dissipation channel width 1700 increases and at least one channel contraction region 1705 in which the dissipation channel width 1700 decreases. For example, the channel contraction region 1705 can be disposed between the channel expansion region 1703 and a channel outlet 1707.

Air flow to the immediately adjacent dissipation fins 1346 may be provided via airflow openings 1704 within endcaps 1706 and via a lighting segment gap opening 1702 extending between immediately adjacent lighting segments of the lighting segments 1502, 1504, 1506, and 1508. Air entering air the airflow openings 1704 flows in direction substantially parallel to a fixture longitudinal axis 1708 (FIG. 15) and air entering via the lighting segment gap opening 1702 may flow in a direction transverse (e.g., perpendicular) to the fixture longitudinal axis 1708.

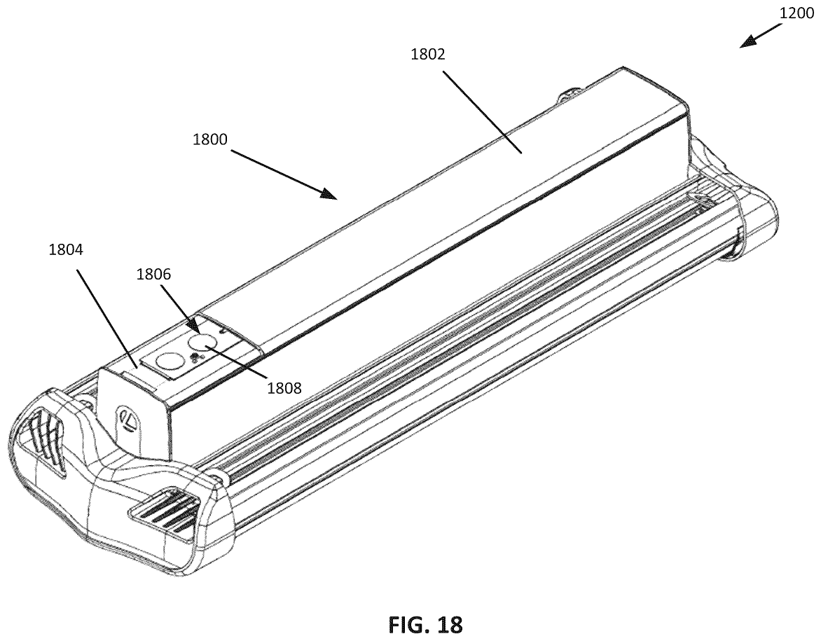

FIG. 18 shows a perspective view of a lighting fixture 1200 that includes a closure cap 1800 having a covering region 1802 and an access region 1804. The access region 1804 may include wire passthroughs 1806 having passthrough covers 1808 that are removable. The wire passthroughs 1806 may be configured to receive electrical wiring for providing power (e.g., mains power) to the power supply 1302.

An example of a lighting fixture, consistent with the present disclosure, may include a frame, a light source coupled to the frame, and a driver. The light source may include a first lighting segment, a second lighting segment spaced apart from the first lighting segment by a first separation distance to form a first gap through which air flows, and a third lighting segment spaced apart from the second lighting segment by a second separation distance to form a second gap through which air flows. The driver may be coupled to the second lighting segment such that the driver is at least partially disposed between the first and second gaps.

In some instances, the driver may include a driver housing, the driver housing including first and second sidewalls, each of the first and second sidewalls having a convex shape. In some instances, the convex shape of the first sidewall causes the first sidewall to protrude in a direction of the first gap and the convex shape of the second sidewall causes the second sidewall to protrude in a direction of the second gap. In some instances, the convex shape of the first and second sidewalls includes an arcuate portion. In some instances, the driver may further include a base plate coupled to the driver housing, the base plate including mounting features configured to couple the driver with the second lighting segment. In some instances, the driver may be mounted to the second lighting segment such that a bottom portion of the driver is spaced apart from a top portion of the second lighting segment by a separation distance. In some instances, the separation distance may be in a range of 0.6 centimeter (cm) to 2 cm. In some instances, the frame may include end caps and the first, second, and third lighting segments extend between the end caps. In some instances, a lighting longitudinal axis of each of the first, second, and third lighting segments may intersect the end caps. In some instances, the lighting longitudinal axes of the first, second, and third lighting segments may be substantially parallel to each other. In some instances, a driver longitudinal axis of the driver may be substantially parallel to the lighting longitudinal axis of the second lighting segment. In some instances, the first and second gaps may be configured to encourage a laminar flow of air passing therethrough. In some instances, the first separation distance and the second separation distance may be in a range of 0.6 centimeter (cm) to 1 cm. In some instances, the first gap may have a first gap length and the second gap may have a second gap length, the first gap length and the second gap length being substantially equal to a second lighting segment length of the second lighting segment. In some instances, the second lighting segment length may correspond to a portion of the second lighting segment that is exposed within the frame. In some instances, the second lighting segment may have a second lighting segment length and a second lighting segment width, the second lighting segment length being greater than the second lighting segment width. In some instances, the second lighting segment length may be at least two times greater than the second lighting segment width. In some instances, the driver may include one or more mounting features and the second lighting segment may include one or more rails configured to engage with a corresponding one of the one or more mounting features. In some instances, the lighting fixture may further include one or more sensors. In some instances, the one or more sensors may include a motion sensor.

Another example of a lighting fixture, consistent with the present disclosure, may include a frame, a light source coupled to the frame, and a driver. The light source may include a first lighting segment and a second lighting segment spaced apart from the first lighting segment by a gap. The driver may be disposed between the first and second lighting segments such that air can flow into the gap and over at least a portion of the driver.

In some instances, the driver may include a driver housing, at least a portion of the driver housing extending into the gap. In some instances, the driver housing may include a driver cavity having an open end and the driver may further include a power supply disposed within the driver cavity and a closure cap coupled to the driver housing at the open end. In some instances, the driver may further include a power supply mounting bracket configured to encourage the power supply to engage one or more sides of the driver housing. In some instances, the driver housing may include a deflector, the deflector extending into the gap. In some instances, the deflector may include a first flow surface and a second flow surface, the first and second flow surfaces converging towards each other in a direction of a gap opening of the gap. In some instances, the first and second flow surfaces may each include a concave shape that opens in a direction of a respective one of the first or the second lighting segment. In some instances, each of the first and second lighting segments may include a light mount, a light generator coupled to the light mount, and a light cover coupled to the light mount and extending over the light generator. In some instances, each light mount may include a light generator platform, the light generator being coupled to the light generator platform, and a plurality of dissipation fins extending away from the light generator platform, the dissipation fins cooperating to form a dissipation cavity that extends between the dissipation fins. In some instances, the dissipation cavity may include a dissipation cavity open end opposite the light generator platform, a first cavity contraction region, a second cavity contraction region disposed between the first cavity contraction region and the dissipation cavity open end, and a first cavity expansion region disposed between the first and second cavity contraction regions.

Another example of a lighting fixture, consistent with the present disclosure, may include a frame including endcaps having airflow openings, a light source coupled to the frame such that air can flow through the airflow openings and over at least a portion of the light source, and a driver. The light source may include a first lighting segment and a second lighting segment spaced apart from the first lighting segment by a gap. The driver may be disposed between the first and second lighting segments such that air can flow into the gap and over at least a portion of the driver.

In some instances, the driver may include a driver housing, at least a portion of the driver housing extending into the gap. In some instances, the driver housing may include a driver cavity having an open end and the driver may further include a power supply disposed within the driver cavity and a closure cap coupled to the driver housing at the open end. In some instances, the driver may further include a power supply mounting bracket configured to encourage the power supply to engage one or more sides of the driver housing. In some instances, the driver housing may include a deflector, the deflector extending into the gap. In some instances, the deflector may include a first flow surface and a second flow surface, the first and second flow surfaces converging towards each other in a direction of a gap opening of the gap. In some instances, the first and second flow surfaces may each include a concave shape that opens in a direction of a respective one of the first or the second lighting segment. In some instances, each of the first and second lighting segments may include a light mount, a light generator coupled to the light mount, and a light cover coupled to the light mount and extending over the light generator. In some instances, each light mount may include a light generator platform, the light generator being coupled to the light generator platform and a plurality of dissipation fins extending away from the light generator platform, the dissipation fins cooperating to form a dissipation cavity that extends between the dissipation fins. In some instances, the dissipation cavity may include a dissipation cavity open end opposite the light generator platform, a first cavity contraction region, a second cavity contraction region disposed between the first cavity contraction region and the dissipation cavity open end, and a first cavity expansion region disposed between the first and second cavity contraction regions.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A lighting fixture comprising:
a frame;
a light source coupled to the frame, the light source including:
a first lighting segment; and
a second lighting segment spaced apart from the first lighting segment by a gap; and
a driver disposed between the first and second lighting segments such that air can flow into the gap and over at least a portion of the driver.

2. The lighting fixture of claim 1, wherein the driver includes a driver housing, at least a portion of the driver housing extending into the gap.

3. The lighting fixture of claim 2, wherein the driver housing includes a driver cavity having an open end and the driver further includes a power supply disposed within the driver cavity and a closure cap coupled to the driver housing at the open end.

4. The lighting fixture of claim 3, wherein the driver further includes a power supply mounting bracket configured to encourage the power supply to engage one or more sides of the driver housing.

5. The lighting fixture of claim 4, wherein the driver housing includes a deflector, the deflector extending into the gap.

6. The lighting fixture of claim 5, wherein the deflector includes a first flow surface and a second flow surface, the first and second flow surfaces converging towards each other in a direction of a gap opening of the gap.

7. The lighting fixture of claim 6, wherein the first and second flow surfaces each include a concave shape that opens in a direction of a respective one of the first or the second lighting segment.

8. The lighting fixture of claim 1, wherein each of the first and second lighting segments include a light mount, a light generator coupled to the light mount, and a light cover coupled to the light mount and extending over the light generator.

9. The lighting fixture of claim 8, wherein each light mount includes:
a light generator platform, the light generator being coupled to the light generator platform; and
a plurality of dissipation fins extending away from the light generator platform, the dissipation fins cooperating to form a dissipation cavity that extends between the dissipation fins.

10. The lighting fixture of claim 9, wherein the dissipation cavity includes:
a dissipation cavity open end opposite the light generator platform;
a first cavity contraction region;
a second cavity contraction region disposed between the first cavity contraction region and the dissipation cavity open end; and
a first cavity expansion region disposed between the first and second cavity contraction regions.

11. A lighting fixture comprising:
a frame including endcaps having airflow openings;
a light source coupled to the frame such that air can flow through the airflow openings and over at least a portion of the light source, the light source including:
a first lighting segment; and
a second lighting segment spaced apart from the first lighting segment by a gap; and
a driver disposed between the first and second lighting segments such that air can flow into the gap and over at least a portion of the driver.

12. The lighting fixture of claim 11, wherein the driver includes a driver housing, at least a portion of the driver housing extending into the gap.

13. The lighting fixture of claim 12, wherein the driver housing includes a driver cavity having an open end and the driver further includes a power supply disposed within the driver cavity and a closure cap coupled to the driver housing at the open end.

14. The lighting fixture of claim 13, wherein the driver further includes a power supply mounting bracket configured to encourage the power supply to engage one or more sides of the driver housing.

15. The lighting fixture of claim 14, wherein the driver housing includes a deflector, the deflector extending into the gap.

16. The lighting fixture of claim 15, wherein the deflector includes a first flow surface and a second flow surface, the first and second flow surfaces converging towards each other in a direction of a gap opening of the gap.

17. The lighting fixture of claim 16, wherein the first and second flow surfaces each include a concave shape that opens in a direction of a respective one of the first or the second lighting segment.

18. The lighting fixture of claim 11, wherein each of the first and second lighting segments include a light mount, a light generator coupled to the light mount, and a light cover coupled to the light mount and extending over the light generator.

19. The lighting fixture of claim 18, wherein each light mount includes:
a light generator platform, the light generator being coupled to the light generator platform; and
a plurality of dissipation fins extending away from the light generator platform, the dissipation fins cooperating to form a dissipation cavity that extends between the dissipation fins.

20. The lighting fixture of claim 19, wherein the dissipation cavity includes:
a dissipation cavity open end opposite the light generator platform;
a first cavity contraction region;
a second cavity contraction region disposed between the first cavity contraction region and the dissipation cavity open end; and
a first cavity expansion region disposed between the first and second cavity contraction regions.
